(19) United States
(12) Patent Application Publication
(10) Pub. No.: US 2021/0125464 A1
(43) Pub. Date: Apr. 29, 2021

(54) SLOT MACHINE, METHOD USING THE SAME, AND INFORMATION RECORDING MEDIUM

(71) Applicant: RISING ENTERTAINMENT CO., LTD., Tokyo (JP)

(72) Inventor: Masayuki HIRATA, Taito-Ku, Tokyo (JP)

(73) Assignee: RISING ENTERTAINMENT CO., LTD., Tokyo (JP)

(21) Appl. No.: 16/605,349

(22) PCT Filed: Oct. 31, 2017
(86) PCT No.: PCT/JP2017/039406

§ 371 Date: Oct. 15, 2019

(51) Int. Cl. G07F 17/34; G07F 17/32

(52) U.S. Cl. CPC G07F 17/34; G07F 17/3213

(57) ABSTRACT

A slot machine 1 is provided with a memory 20 that stores data and a processor 30 that performs processing. The processor 30 includes an RS number determination unit 31 that determines a natural number in a predetermined range as the number of reel strips via a selection; an assigning unit 32 that extracts reel strips with the determined number from the stored reel strips to assign the extracted reel strips to each of the reel windows; a acceptance/refusal determination unit 33 that determines acceptance/refusal of winning combination via a selection in a slot game, using the extracted reel strips; and a display control unit 34 that variably displays the reel strips in response to the reel strips with the determined number, the assignment of the reel strips to the each of the reel windows, and the acceptance/refusal of the slot game combination.

### TECHNICAL FIELD

The present invention relates a slot machine that stores a plurality of reel strips, and variably displays symbols with a plurality of reel windows; and a method using the same, and an information recording medium thereof.

### BACKGROUND ART

Conventionally, provided has been a slot game in which data for which a plurality of symbols are continuously arranged is stored as a reel strip, and this is variably displayed and stop-displayed in each reel window.

The gaming machine disclosed in Patent Document 1, that is arranged in such a manner that virtual reels correspond to a plurality of cells, respectively, determines a symbol to which stopping is made at each cell via a selection, and controls movement that changes the symbol and a stop of the movement of each virtual reel based on a selecting result. Then, when the virtual reel stops so that a variable symbol area appears in a cell, the virtual reel maintains the rotation of an inner reel while stopping scrolling of itself.

### PRIOR ART DOCUMENT

### Patent Document

Patent Document 1: Japanese Unexamined Patent Application Publication (Translation of PCT Application) No. 2015-526247

### SUMMARY OF THE INVENTION

### Problems to be Solved by the Invention

As described above, known has been a slot machine comprising a plurality of reel windows (cells) displaying a single symbol, and variably displays and stop-displays symbols with each of the reel windows, using reel strips corresponding to the reel windows. However, kinds of the reel strips are not increased or decreased for every game, and thus there is no technique of improving the diversity in win and non-win, and of realizing diverse displays using the whole display area.

The present invention has been made in view of such a situation, and it is an object to provide a slot machine capable of enhancing a player's expectancy and sense of satisfaction by realizing diverse reel displays and making win patterns be rich, and to provide a method using the same and an information recording medium thereof.

### Means to Solve the Problems

In order to achieve the above-described object, according to a slot machine of the present invention, there is provided a slot machine that stores a plurality of reel strips and variably displays symbols with a plurality of reel windows, the slot machine comprising a memory that stores data and a processor that performs processing, wherein the processor comprises an RS number determination unit that determines a natural number in a predetermined range as the number of reel strips via a selection; an assigning unit that extracts reel strips with the determined number from the stored reel strips to assign the extracted reel strips to each of the reel windows; a acceptance/refusal determination unit that determines acceptance/refusal of a winning combination of a slot game via a selection, using the extracted reel strips; and a display control unit that variably displays the reel strips in response to the reel strips with the determined number, the assignment of the reel strips to the each of the reel windows, and the acceptance/refusal of the winning combination of the slot game.

### Effect of the Invention

According to the present invention, a player's expectancy and sense of satisfaction can be enhanced by realizing diverse reel displays, and making win patterns be rich.

### BRIEF DESCRIPTION OF THE DRAWINGS

FIG. 1 is a perspective view showing an example of appearance of a slot machine.

FIG. 2 is a block diagram showing an electrical configuration of a slot machine.

FIG. 3 is a block diagram showing a functional configuration of a slot machine.

FIG. 4 is a diagram showing an example of reel strips.

FIG. 5 is a diagram showing a configuration of reel windows with three lateral lines and five vertical lines.

FIGS. 6A and 6B are diagrams showing a variable display and a stop display, respectively, when assigning 3 reel strips to reel windows with three lateral lines and five vertical lines.

FIGS. 7A and 7B are diagrams showing a variable display and a stop display, respectively, when assigning one reel strip to reel windows with three lateral lines and five vertical lines.

FIG. 8 is a flowchart showing an action of a slot machine.

FIGS. 9A and 9B are diagrams showing a variable display and a stop display, respectively, when assigning 2 reel strips to reel windows with three lateral lines and five vertical lines at 1:14.

FIGS. 10A and 10B are diagrams showing a variable display and a stop display, respectively, when assigning 2 reel strips to reel windows with three lateral lines and five vertical lines at 7:8.

FIGS. 11A and 11B are diagrams showing a variable display and a stop display, respectively, when using reel windows each in which a block area is partially occupied.

FIGS. 12A and 12B are diagrams showing a variable display and a stop display, respectively, when assigning 2 reel strips to reel windows with one lateral line and three vertical lines.

### DETAILED DESCRIPTION OF EMBODIMENTS

Next, embodiments of the present invention will be described referring to the drawings. in order to facilitate understanding of the description, the same numeral reference numerals will be used for the same constituent elements, and overlapping descriptions will be omitted in each drawing.

### First Embodiment

### (Configuration of Slot Machine)

### (1) Overall Configuration

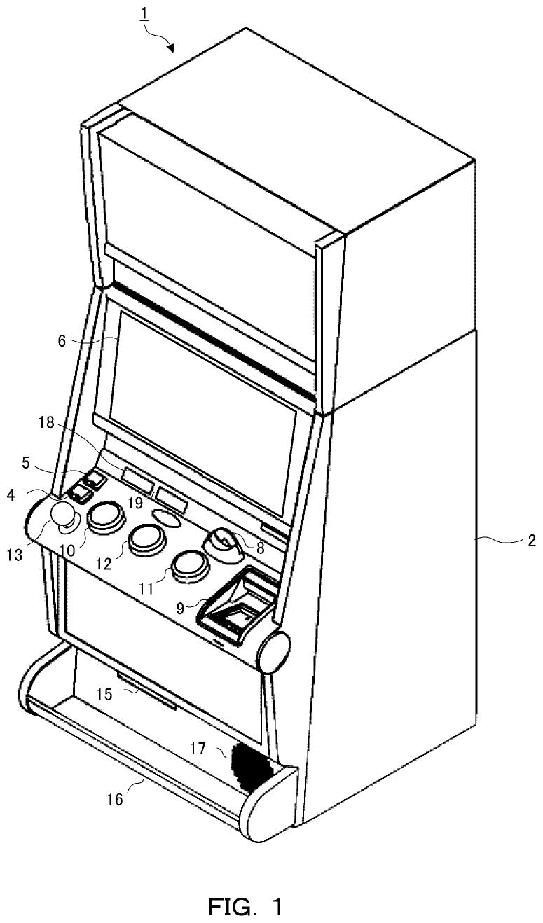

FIG. 1 is a perspective view showing an example of appearance of a slot machine 1. The slot machine 1 is a so-called video reel slot machine with which variable control and stop control of symbols are carried out by video reels displayed on a display 6. A slot game is provided to a player by the slot machine 1.

The slot machine 1 displays the rotation of each reel for which a plurality of symbols are arranged, and determines prize-winning with respect to the prize in an ordinary game. That is, a plurality of reel strips are stored as data in which the symbols are arranged, and the symbols are variably displayed and stop-displayed with a plurality of reel windows using the reel strips. In addition, in the following explanation, “acceptance” means a state where processing in a control unit causes acceptance of a prize, and “win” means a state where a player actually acquires the prize after receiving the acceptance.

In addition, the “reel” means a display array for which a plurality of symbols are arranged to be variably displayable, and the symbols of the display array are variably displayed by spinning the reel (virtual rotation for the video reel). The “reel window” means a frame capable of visualizing a part of the symbols of respective reels for a player. The “cell” is an independent display unit on a matrix provided on an image plane of the display 6, and the reel windows are basically constituted of cells according to the present embodiment. For example, an image plane is divided into five lateral lines and five vertical lines, and displayed by arranging one symbol data to one cell that has been divided therein.

In the following description, by specifying the arrangement in the direction when viewed from the player, the display 6 side of the slot machine 1 is described as an “upper” side; the coin receiving tray 16 side is described as a “lower” side; the spin lever 13 side is described as a “left” side; and the bill inserting port 9 side is described as a “right” side.

The slot machine 1 comprises a housing 2 and a body unit provided inside the housing 2. The display 6 is provided in the body unit in such a manner that a display of the game can be viewed from the front face of the housing 2. The display 6 displays not only symbol arrays but also guidance for the operating method, a special game or the like. Any of a liquid crystal display, CRT, an organic EL display and so forth may be used for the display 6.

The coin inserting port 8 and the bill inserting port 9 are provided on the front face of the housing 2. The bet button 10 is a button operated by the player in order to bet a game medium required for starting a game. Only a predetermined number of game media (coins stored in a coin storage device that is not shown in the figure) is consumed when a specific line is specified by this button, and the specified line becomes a bet line. The MAX bet button 11 is a button for using a maximum prescribed number of coins stored in the coin storage device that is not shown in the figure. In addition, the “WIN line” means a line at which win can be achieved, that is inclusive of the bet line.

The “game medium” includes not only a tangible object corresponding to a “coin”, a “medal” or a “token” conventionally used for the slot machine 1, but also a virtual medal and so forth given and received, and circulated by using an electronic recording medium and the like such as a magnetic card, an IC card and so forth. In the present specification, the “game medium” is mainly exemplified by the “coin”. The “credit” means information indicating the number of game media stored electrically or magnetically in a game machine, and the number thereof is referred to as “the number of credits”.

The “bet” means that the game medium required for starting a game is set. The bet game medium is consumed by starting the game. The number of game media set for starting the game is referred to as a “bet number”.

The spin button 12 is a button operated by a player in order to instruct a start of the game. The symbols start to be variably displayed on the display 6 by pushing the spin button 12. The spin lever 13 has the same function. In addition, provided may be a stop button for forcibly advancing to stop a variable display of symbols on each reel.

The “game” means a sequential process until completing a processing based on acceptance/refusal determination from when staring the variable display of symbols with each reel window, by responding to the start lever operation. The “one game” means one time of the sequential process.

The coin payout port 15, the coin receiving tray 16 and a speaker 17 are provided at the lower side of the front face of the housing 2. The settlement button 4 is a button for performing settlement of stored coins. The help button 5 has a function of displaying how to play, dividends and so forth on the display 6. The “pay table” is a table showing winning combinations and the dividends corresponding to the winning combinations, and the pay table may be displayed on the display 6 by pushing down the help button 5.

The “winning combination” means a symbol combination pattern associated with a predetermined privilege. The privilege corresponding to a winning combination is granted when the symbol combination corresponding to the winning combination is stop-displayed on a WIN line. The “acceptance” of a winning combination is meant to be a state where the symbol combination corresponding to the winning combination will be stop-displayed on the WIN line. The winning combination is roughly classified in a bonus combination, a small combination and a regaming combination according to types of privileges. The small combination is a winning combination by which coins are pay out via prize-winning. The regaming combination is a winning combination by which a game can be started again with no additional bet in response to the prize-winning. The bonus combination is a winning combination serving for triggering the shift to an advantageous state concerning the payout of coins such as a bonus game or the like.

The payout number display unit 18 displays the number of payout coins. The coin storage number display unit 19 displays the number of coins stored in the coin storage device that is not shown in the figure. LED or liquid crystal, for example, can be used for the payout number display unit 18 and the coin storage number display unit 19.

### (2) Electrical Configuration

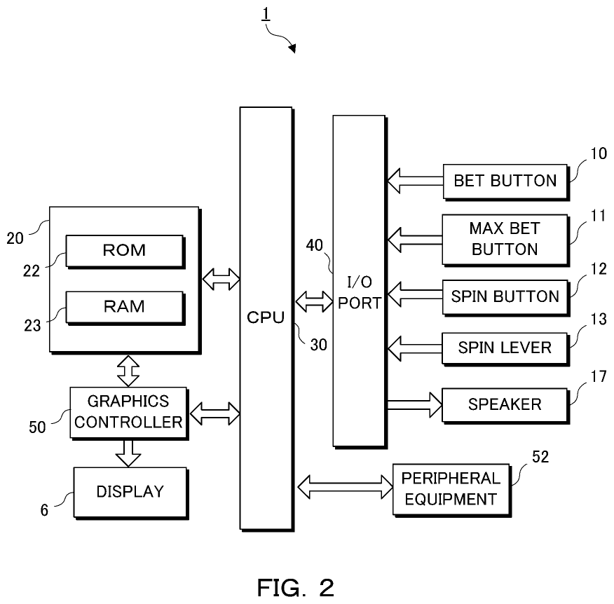

FIG. 2 is a block diagram showing an electrical configuration of a slot machine. The body unit of the slot machine 1 comprises a memory 20 constituted of ROM 22 and RAM 23, a CPU 30, and an I/O port 40.

The memory 20 stores plural kinds of element data and so forth that become elements for diverse kinds of visual effect programs, a symbol array table, a win table, and image data in addition to a control program for controlling the action of the slot machine 1. The memory 20 serves as a storage unit.

The CPU (processor) 30 executes processing in accordance with a preset program. For example, the CPU 30 serves as a random number generation unit for generating each of random numbers and a combination of the random numbers corresponding to symbol arrays by receiving a start signal. Further, the CPU 30 serves as a acceptance/refusal determination unit for determining the acceptance by determining the arrangement of a plurality of symbols corresponding to the generated random numbers or a combination of the random numbers.

The CPU 30 is connected to a bet button 10, a MAX bet button 11, a spin button 12, a spin lever 13 and a speaker 17 via an I/O port 40. Signals output from the bet button 10 and the spin lever 12 are input to the CPU 30 via the I/O port 40. Each of the spin button 12 and the spin lever 13 serve as a start unit for generating the start signal.

The display 6 outputs image data transmitted from the CPU 30. The display 6 can display letters, still images, moving images and so forth by carrying out image processing or the like. The display 6 displays an ordinary game, a bonus game and a free game, and also displays other games.

### (3) Functional Configuration

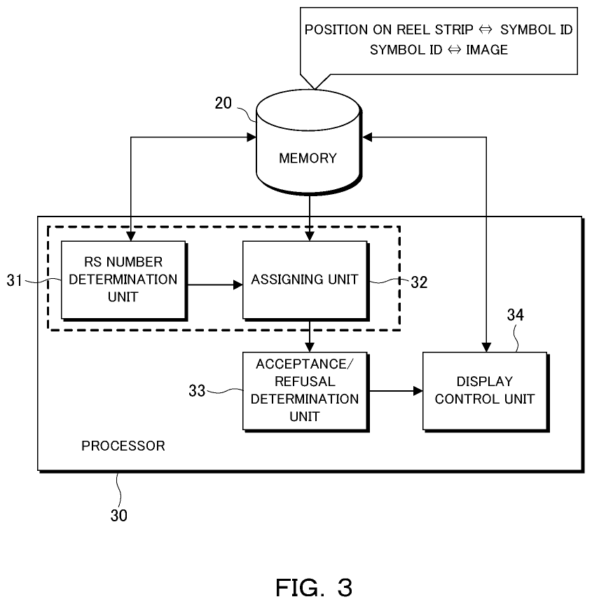

FIG. 3 is a block diagram showing a functional configuration of a slot machine 1. The CPU (processor) 30 provided with at least an RS number determination unit 31, an assigning unit 32, a acceptance/refusal determination unit 33, and a display control unit 34 executes processing while reading data from the memory 20. In addition, each unit is made to function via execution of a program.

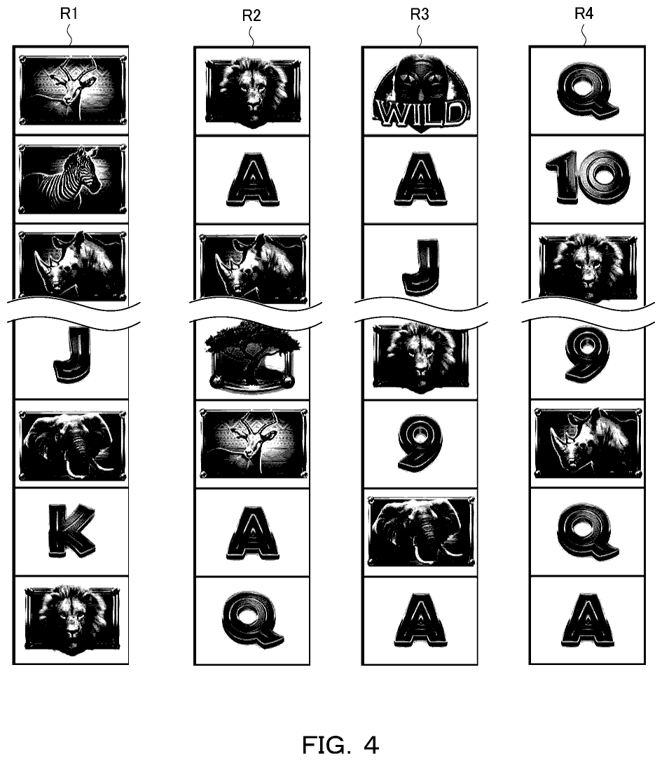

The memory 20 stores data of a plurality of reel strips. FIG. 4 is a diagram showing reel strips R1 to R4 as an example. Symbols are arranged in each of the reel strips R1 to R4 in a predetermined order. For examples, in the reel strip R1, arranged are symbols of an impala, a zebra, a rhinoceros, . . . , J, an elephant, K, a lion at each of positions 1 to 7. In addition, the wild symbol arranged at the first position in the reel strip R3 is a symbol used as a substitute for another symbol when determining acceptance/refusal in the ordinary game.

In symbols, included may be wild symbol-like “special symbols” other than “ordinary symbols”. The “special symbols” may be, for example, those in which prize-winning is achieved only by being stop-displayed in the special display area or at the WIN line, or may be the after-mentioned “trigger symbols”.

In the memory 20, stored are, for example, a table in which the position on the reel strip is associated with the symbol ID, and a table in which the symbol ID is associated with the image. In addition, the number of symbols that constitutes one reel strip is not specifically limited.

Conventionally, the corresponding relationship between each of reel strips and each of reel windows has been fixed when advancing one game. However, according to the present invention, the assignment of these reel strips to each of the reel windows is changed for every game, and the identical reel strips are assigned to a plurality of different reel windows in accordance with the selection.

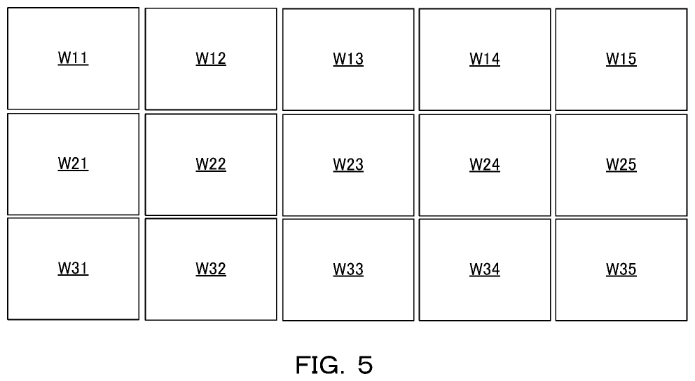

FIG. 5 is a diagram showing a configuration of reel windows W11 to W35 with three lateral lines and five vertical lines (as to the after-mentioned example of reel windows with three lateral lines and five vertical lines as well, the reel windows arranged thereon are represented by W11 to W35). According to a conventional example, an independently specific reel strip is assigned to each of reel windows W11 to W35. For example, if a reel strip R1 is assigned to a reel window W11, the corresponding relationship between the reel window W11 and the reel strip R1 is not changed during a game play.

However, according to the present invention, the number of reel strips, extracted reel strips, and assignment of the extracted reel strips to each of reel windows are determined via a selection with random numbers, and the corresponding relationship between the reel windows W and the reel strips is changed. For example, reel strips R2 and R3 among reel strips R1 to R4 are extracted via a selection, and further, as a result of another selection, it is possible that the reel strip R2 is assigned to reel windows W11, W14, W21, W22, W24, W25, W31, and W33 and the reel strip R3 is assigned to reel windows W12, W13, W15, W23, W32, W34, and W35. Reel strips are varied in this manner. The configuration of each unit that enables the variation of reel strips in this manner will be described below.

The RS number determination unit 31 determines a natural number in a predetermined range as the number of reel strips via a selection. When determining the number of reel strips, a random number is acquired, and one natural number is determined based on the random number. For example, when storing 15 reel strips in the memory 20, any of natural numbers 1 to 15 can be determined. As a predetermined range, allowed is a natural number smaller than the number of stored reel strips, and for example, when storing 15 reel strips, any of natural numbers 1 to 5 is allowed to be determined.

The assigning unit 32 extracts reel strips with the determined number from the stored reel strips. Then, the extracted reel strips are assigned to each of the reel windows. When carrying out a slot game with the assigned reel strips in this way, a player's expectancy and sense of satisfaction can be enhanced by realizing diverse reel displays, and making win patterns be rich.

The reel strips can be “equally divided”, and assigned to each of the reel windows via a selection by the assigning unit 32. The acquired random number is used for the selection of the assignment. For example, when assigning 5 reel strips to 15 reel windows, the equally dividing assignment becomes possible by assigning identical reel strips for every 3 reel windows. Accordingly, the number of assigned reel strips can be clearly displayed.

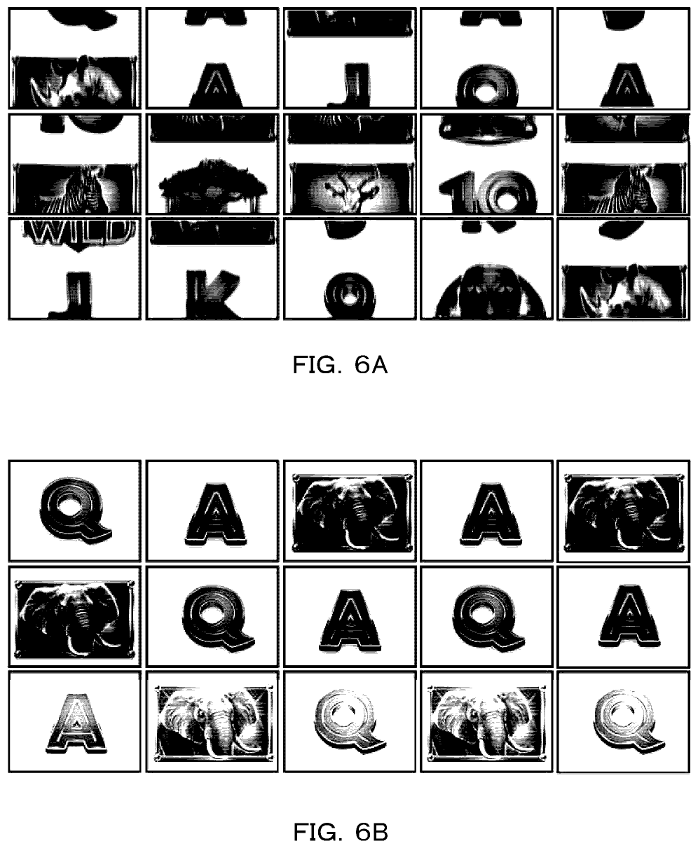

FIGS. 6A and 6B are diagrams showing a variable display and a stop display, respectively, when assigning 3 reel strips to reel windows with three lateral lines and five vertical lines. According to the example shown in FIGS. 6A and 6B, “3” is determined as the number of reel strips, and 3 different reel strips are extracted and assigned to reel windows with three lateral lines and five vertical lines. After this, a selection for acceptance/refusal of a winning combination is carried out, and the variable display and the stop display of symbols are performed.

According to the above-described example, the first reel strip in the 3 reel strips is assigned to reel windows W11, W22, W24, W33, and W35; the second reel strip is assigned to reel windows W12, W14, W23, W25, and W31; and the third reel strip is assigned to reel windows W13, W15, W21, W32, and W34.

As shown in FIG. 6A, at the time of the variable display, reel strips are variably displayed at separate phases even for reel windows to which identical reel strips are assigned. Then, as shown in FIG. 6B, when stop-displaying symbols, the stop-display has been performed at the identical symbol positions (Q, A, elephant) by each assignment.

In this way, even though being reel windows for which identical reel strips are arranged, the variable display really does not need to be synchronized, and the variable display may be performed at each speed and in each timing. However, it is understood by a player that identical reel strips have been selected when identical symbols are stopped at the time of the stop-display.

The variable display may be performed at the same phase with reel windows for which assigned reel strips are identical to each other. Thus, in the case of reel windows to which identical reel strips are assigned, the same variable display is performed, and thus as to a selecting result through the assignment, a sense of expectation can be given to the player.

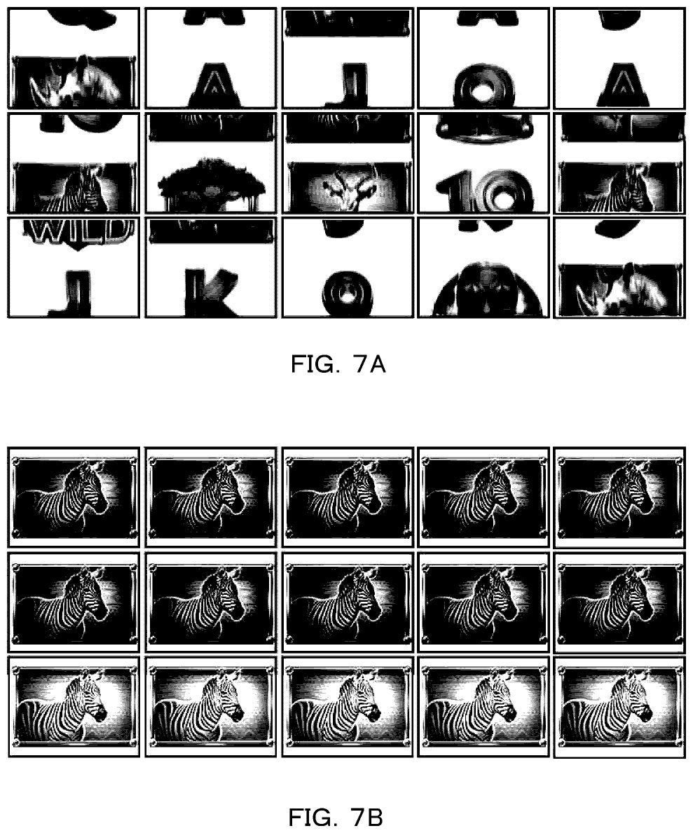

FIGS. 7A and 7B are diagrams showing a variable display and a stop display, respectively, when assigning one reel strip to reel windows with three lateral lines and five vertical lines. According to the example shown in FIGS. 7A and 7B, “1” is determined as the number of reel strips, and one reel strip is extracted and assigned to all of the reel windows with three lateral lines and five vertical lines. Then, a selection for acceptance/refusal of a winning combination is carried out, and the variable display and the stop display of symbols are performed. In this case, identical symbols are stop-displayed in all of the reel windows with three lateral lines and five vertical lines, and a win is confirmed with all the WIN lines. Symbols stop-displayed out of one extracted reel strip are only varied, and accordingly, varied is an accepted winning combination.

In addition, when the number of reel windows is indivisible by the reel strips with the determined number, the distribution may be made by the number of reel windows, that is closest to the equally divided number. For example, when 2 reel strips are assigned to 15 reel windows, reel strips in one side are assigned to 7 reel windows, and reel strips in the other side are assigned to 8 reel windows.

The acceptance/refusal determination unit 33 determines acceptance/refusal of a winning combination in a slot game via a selection, using extracted reel strips. The acquired random number is used for the selection for acceptance/refusal of a winning combination of a slot game. The determination of acceptance/refusal means that at least one acceptance from a plurality of predetermined winning combinations, or refusal of refusing any of the winning combinations is determined via the selection, based on the assigned reel strips. At the time, the determination can be made by using a “configuration table of winning combinations” stored in the memory 20. The “configuration table of winning combinations” means a table in which symbol combinations corresponding to winning combinations, and the privilege thereof are defined.

The display control unit 34 variably displays the reel strips in response to the reel strips with the determined number, the assignment of the reel strips to each of the reel windows, and the acceptance/refusal of the winning combination of the slot game. First, the reel strips are arranged and variably displayed based on the reel strips with the determined number, and the assignment of the reel strips to each of the reel windows. In addition, the variable display means a display on which symbol positions are varied one after another by virtually spinning reels. Further, the symbol position means a virtual reel rotation position determined by a position of a symbol displayed in a reel window with respect to variable display of the symbol.

According to the above-described example, while the number of reel strips and the assignment thereof are made to be identifiable to a player when stop-displaying symbols, the determination of the number of the reel strips and the assignment to reel windows may be displayed before stop-displaying of the symbols, to enhance a performance effect. In that case, the display control unit 24 performs displaying by varying the number of reel strips and the assignment of the reel strips to each reel window, and subsequently performs displaying by fixing to those that are determined. Thus, a sense of expectation is given to a player by displaying the selecting process of the number of reel strips in an easy-to-understand manner.

The reel window is preferably displayed as a frame (cell) capable of independently displaying only a single symbol. By this, a plurality of reel windows that are independently variably displayable can be acquired, and diverse reel displays can be realized in response to the number of strips and the assignment thereof. In addition, reel windows may be those that can simultaneously display a plurality of symbols, and details in such a case will described later.

The reel windows are preferably arranged with a matrix of plural lateral lines and plural vertical lines. This can produce a plurality of easy-to-win WIN lines in response to the number of reel strips and the assignment of the reel strips to improve the diversity of games. For example, in the case of an example of FIG. 5, it is displayed to be arranged with three lateral lines and five vertical lines. In addition, it may be displayed to be arranged with three lateral lines and three vertical lines, or with five lateral lines and five vertical lines.

Further, each of at least one set of reel strips that are different from each other among reel strips stored in the memory 20 preferably comprises one or more identical symbols. Accordingly, the identical symbols are stop-displayed to possibly result in a big win even in the case of reel windows to which a plurality of different reel strips are assigned, and thus a sense of expectation is given to a player.

For example, reel windows to which reel strips in one side are assigned and reel windows to which reel strips in the other side are assigned are generated, when the number of reel strips is determined to be 2. Symbols that are basically different from each other are stop-displayed in reel windows, respectively, however there is a symbol that is common to 2 reel strips, and it is also possible that the common symbol is stop-displayed in each reel window. In that case, all the reel windows are stop-displayed to be identical symbols, and a win is confirmed with all the WIN lines.

Specifically, the reel strips R1 and R2 in FIG. 5 each include a symbol of a lion and a symbol of a rhinoceros. When the reel strips R1 and R2 have been extracted, the case where a symbol of a lion or a rhinoceros is stop-displayed in all the reel windows possibly occurs.

### (Action of Slot Machine)

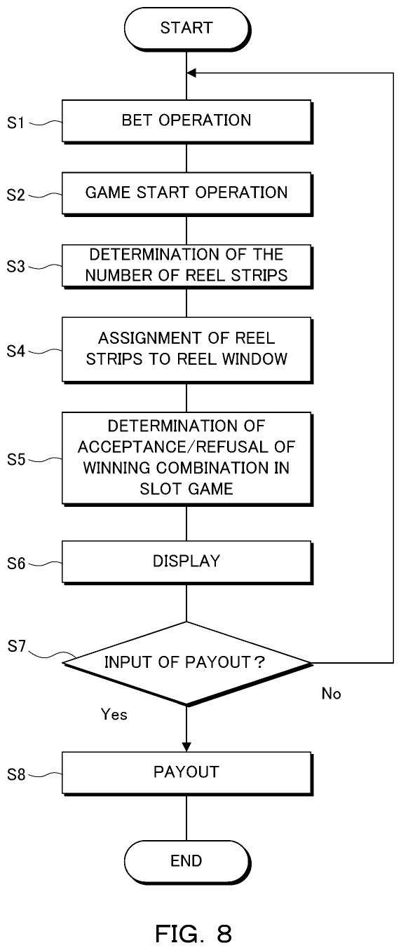

An action of a slot machine 1 constituted as described above will be described. FIG. 8 is a flowchart showing the action of the slot machine 1. First, the slot machine 1 enters a bootable state by receiving a bet operation of a player (step S1). Then, received is a normal game start operation of pushing a spin button and pulling a spin lever (step S2).

Next, the number of reel strips is determined via a selection from a natural number in a predetermined range by taking the number of reel strips stored in a memory as the maximum number (step S3). Reel strips with the determined number are extracted via a selection, and each of the extracted reel strips are assigned to each of the reel windows (step S4).

Then, acceptance/refusal of a winning combination of a slot game is determined, using the assigned reel strips (step S5). The acceptance/refusal of a prize is determined through the result of the arrangement of a plurality of symbols. The variable display and stop-display are performed by varying symbols, and controlling the reel rotation display in response to the determination of the number of reel strips, and the extraction and assignment of the reel strips (step S6).

Whether or not an input of payout has been performed by a settlement button is determined (step S7), and the payout is performed when having been input (step S8) to finish a game. The case where no input of payout has been performed results in returning to the step S1.

In addition, stopping of symbols may be stopped when receiving a stopping operation by a stop button, and may be automatically stopped after a predetermined period of time. Acceptance in internal selection is determined, and a predetermined symbol combination is displayed as any of accepted winning combinations during stopping.

While the above-described processing is processing in the case of a normal game, processing the variation of reel strips can be applied even to a free game and a bonus game. The “free game” means a special game to which a predetermined number of games are provided without consuming any of game media. Further, the “bonus game” means a game to which a predetermined bonus privilege is additionally applied. For example, the condition is set so as to enter these games, when a winning combination obtained from trigger symbols that are different from ordinary symbols is achieved. The “privilege” basically means a dividend by a game medium. The privilege includes an indirect dividend so as to be the right of entering an advantageous state for a player.

The above-described action is performed by executing a program. The program is computer-readable, and is stored in a non-transitory information recording medium.

### Second Embodiment

According to the above-described embodiment, while reel strips assigned to reel windows are equally divided, all of the reel strips with the determined number without arranging such restriction may be distributed to any of the reel windows, and assigned via a selection. By doing this, the range between win and non-win becomes wide. The easiness of winning is changed according to the assignment of reel strips, and thus the variations in acceptance/refusal of a winning combination of a slot game become rich.

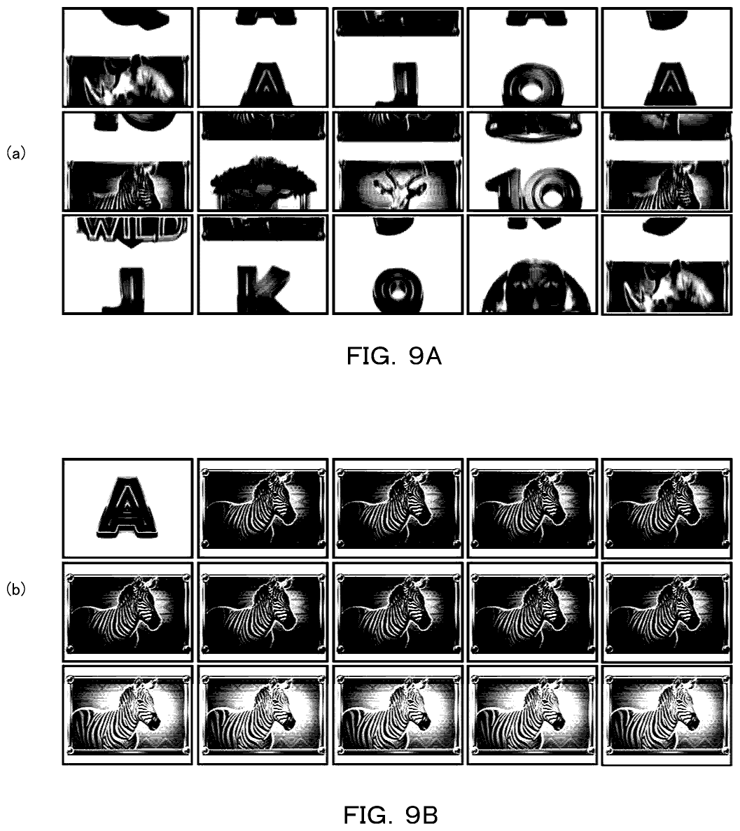

FIGS. 9A and 9B are diagrams showing a variable display and a stop display, respectively, when assigning 2 reel strips to reel windows with three lateral lines and five vertical lines at 1:14. In such a manner, in the case of the number of reel strips being 2 as well, if the reel strips are assigned to each of one reel window and 14 reel windows, a plurality of WIN lines win at 14 reel windows to which identical reel strips are assigned. In this case, an easy winning situation is created when the assignment is determined.

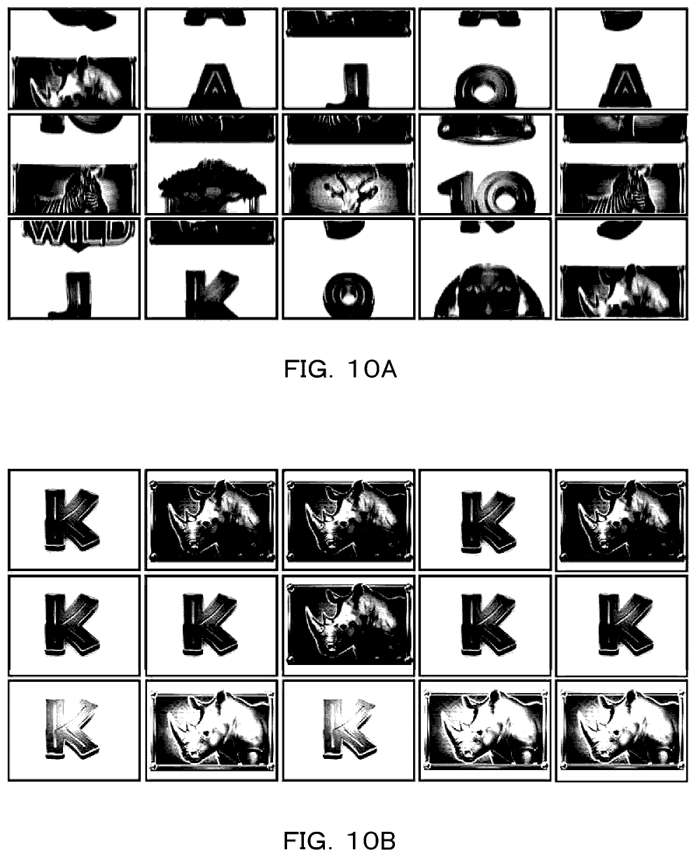

FIGS. 10A and 10B are diagrams showing a variable display and a stop display, respectively, when assigning 2 reel strips to reel windows with three lateral lines and five vertical lines at 7:8. This case is in the same situation as the case where reel strips are equally divided, and 2 reel strips are distributed to 15 reel windows, and thus the winning is hardly created, compared with the case at 1:14.

### Third Embodiment

According to the above-described embodiment, while each of reel windows are uniform in size, the reel windows in different size may be formed by integration of the reel windows with each other. For example, it is enabled that the reel windows each occupy a unit area in uniform size in a basic mode; and a part of the reel windows occupies a block area in larger size than the uniform size in an irregular mode, the block area being formed by integration of a plurality of unit areas adjacent to each other. In this way, the variations can be given to a game and a display thereof to constitute diverse WIN lines. The shift to the irregular mode from the basic mode can trigger, for example, a stop-display of a special symbol, achievement of a special winning combination, and so forth.

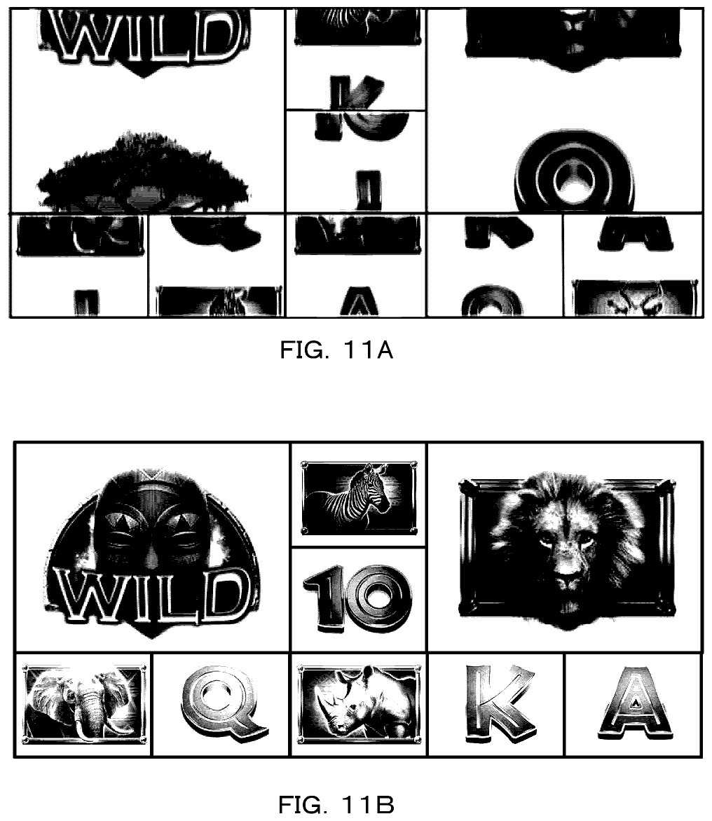

FIGS. 11A and 11B are diagrams showing a variable display and a stop display, respectively, when using reel windows each in which a block area is partially occupied. According to examples shown in FIGS. 11A and 11B, the game has shifted to the irregular mode from the basic mode, and reel windows W11, W12, W21, and W22 are integrated to display a symbol as one big reel window. Similarly, reel windows W14, W15, W24, and W25 are integrated to display a symbol as one big reel window. The other reel windows maintain the same size as in the basic mode. In this case, the integrated reel window produces the same effect as that of a stop-display of 4 identical symbols, and acceptance of a winning combination is easily made at WIN lines that overlap with the block area.

### Fourth Embodiment

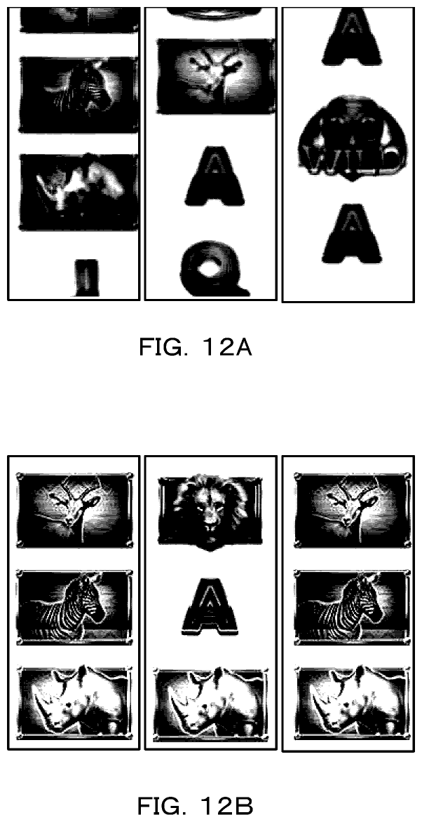

According to the above-described example, while the reel windows are arranged with plural lateral lines and plural vertical lines, the arrangement may be made with a matrix of one single lateral line and plural vertical lines. FIGS. 12A and 12B are diagrams showing a variable display and a stop display, respectively, when assigning 2 reel strips to reel windows with one lateral line and three vertical lines. In this case, reel windows are arranged in only one lateral line, and reel windows with each of vertical lines can simultaneously display 3 symbols. In the case of a configuration of such reel windows, influence of the number of reel strips and the assignment of the reel strips is simplified, thereby being able to provide games in which these changes are easily understandable.

### EXPLANATION OF THE SYMBOLS

1 slot machine
2 housing
4 settlement button
5 help button
6 display
8 coin inserting port
9 bill inserting port
10 bet button
11 MAX bet button
12 spin button
13 spin lever
15 coin payout port
16 coin receiving tray
17 speaker
18 payout number display unit
19 coin storage number display unit
20 memory
22 ROM
23 RAM
24 display control unit
30 CPU (processor)
31 RS number determination unit
32 assigning unit
33 acceptance/refusal determination unit
34 display control unit
40 I/O port
R1 to R4 reel strip
W11 to W35 reel window

1. A slot machine that stores a plurality of reel strips and variably displays symbols with a plurality of reel windows, the slot machine comprising a memory that stores data and a processor that performs processing,
wherein the processor comprises an RS number determination unit that determines a natural number in a predetermined range as the number of reel strips by a selection;
an assigning unit that extracts reel strips with the determined number from the stored reel strips to assign the extracted reel strips to each of the reel windows;
a acceptance/refusal determination unit that determines acceptance/refusal of a combination of a slot game via a selection, using the extracted reel strips; and
a display control unit that variably displays the reel strips in response to the reel strips with the determined number, the assignment of the reel strips to the each of the reel windows, and the acceptance/refusal of the winning combination in the slot game.

2. The slot machine according to claim 1,
wherein all of the reel strips with the determined number are distributed to any of the reel windows, and assigned via a selection by the assigning unit.

3. The slot machine according to claim 2,
wherein the reel strips with the determined number are equally assigned to the each of the reel windows via a selection by the assigning unit.

4. The slot machine according to claim 1,
wherein each of the reel windows are displayed as a frame with which only a single symbol can be independently displayed.

5. The slot machine according to claim 4,
wherein the reel windows are arranged with a matrix of plural lateral lines and plural vertical lines.

6. The slot machine according to claim 5,
wherein each of the reel windows occupy a unit area in uniform size in a basic mode; and partially occupy a block area in larger size than the uniform size in an irregular mode, the block area being formed by integration of a plurality of unit areas adjacent to each other.

7. The slot machine according to claim 4,
wherein the reel windows are arranged with a matrix of single lateral line and plural vertical lines.

8. The slot machine according to claim 1,
wherein the variably displaying is carried out at the same phase for the reel windows for which the assigned reel strips are identical to each other.

9. The slot machine according to claim 1,
wherein each of at least one set of reel strips that are different from each other among the stored reel strips comprises one or more identical symbols.

10. A method of providing a game using a slot machine that stores a plurality of reel strips and variably displays symbols with a plurality of reel windows, the method comprising the steps of:
determining a natural number in a predetermined range as the number of reel strips via a selection;
extracting reel strips with the determined number from the stored reel strips;
assigning the extracted reel strips to each of the reel windows;
determining acceptance/refusal of a combination of a slot game via a selection, using the extracted reel strips; and
variably displaying the reel strips in response to the reel strips with the determined number, the assignment of the reel strips to the each of the reel windows, and the acceptance/refusal of the winning combination in the slot game.

11. A non-transitory information recording medium having stored therein a computer-readable program executed with a slot machine comprising a memory that stores data and a processor that performs processing, that stores a plurality of reel strips and variably displays symbols with a plurality of reel windows, the program causing a computer to execute the processings of:
determining a natural number in a predetermined range as the number of reel strips via a selection;
extracting reel strips with the determined number from the stored reel strips;
assigning the extracted reel strips to each of the reel windows;
determining acceptance/refusal of a winning combination in a slot game via a selection, using the extracted reel strips; and
variably displaying the reel strips in response to the reel strips with the determined number, the assignment of the reel strips to the each of the reel windows, and the acceptance/refusal of the winning combination in the slot game.
